(19) United States
(12) Patent Application Publication
(10) Pub. No.: US 2007/0171084 A1
(43) Pub. Date: Jul. 26, 2007

(54) Personal safety device

(76) Inventor: David Edward Potter, London (GB)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/597,704

(22) PCT Filed: Mar. 4, 2005
(86) PCT No.: PCT/GB05/00851

§ 371 Date: Sep. 8, 2006

(30) Foreign Application Priority Data
Jan. 25, 2005 (GB) 0501371.9
Mar. 10, 2004 (GB) 0405344.3

(51) Int. Cl. G08B 17/10

(52) U.S. Cl. 340/628

(57) ABSTRACT

A personal safety device (21) comprises a casing (22) having a torch (23) and a smoke detector at opposite ends. When not in use, the smoke detector is protoected by an end cap (33) making a water tight seal with the casing (22). The end cap (33) is biased to slide away from the casing (22) when unlatched, exposing a louvered chamber (9) containing the smoke detector. The smoke detector is automatically activated when the chamber (9) is exposed, and should it detect a fire operates both an audible alarm (30) and the torch (23). Buttons (35, 36) are provided to allow activation of the audible alarm (30) as an attack alarm or controllably as a signaling device. The torch (23) compriss one or a plurality of white LEDs (26) for conventional illumination and optionally a red LED (27) for signaling and for illumanition without loss of night vision.

The present invention relates to a device for ensuring safety. More particularly, but not exclusively, it relates to an easily transportable combination of a torch and a smoke alarm.

A frequent concern of campers, back packers and other travelers is that they might be caught up in a fire while sleeping, and be injured or killed. While most modern hotels will be provided with emergency lights and with permanently-installed and regularly maintained fire alarm systems linked to smoke detectors and the like, this may not be the case in hotels, guesthouses and the like in less-developed parts of the world, and is most unlikely to be the case on campsites, whether organised or ad hoc.

It is therefore desirable to provide a personal fire and smoke alarm that a traveler can easily carry with him or her and set up when required.

Once an alarm has been given, the traveler still needs to escape. Smoke may already be limiting visibility, it will often be night time, and any existing lighting systems may well have failed (they may indeed be the cause of the fire in more ramshackle premises). The traveler will hence require his or her own source of light, such as a torch, immediately to hand.

Proposals have hence been made for portable smoke alarms with electric light sources built into their casings, such as that described in U.S. Pat. No. 4,419,658. However, while the device described therein could be deployed on a bedside cabinet or hooked over a headboard, it is not suitable for use as a torch to be carried by the traveler while searching for an escape route.

U.S. Pat. No. 4,862,148 discloses a device having the general configuration of a hand torch, with a smoke detector and associated alarm mounted to a butt end of the torch. This is a conveniently transportable item and can also be used as a conventional torch.

However, the device disclosed includes an exposed position of the smoke detector, which is enclosed in a cylindrical mesh housing, forming the butt of the device. The housing thus allows continuous access to the smoke detector by airborne particulates and vapours, whether or not the detector is actually switched on. As a result, if the device were to be used as a torch in a smoky area, for example near a campfire, smoke particles could enter the housing and linger, causing false alarms when the detector is subsequently turned on at a separate location.

The mesh housing may also reduce the device's usefulness as a torch. It is clearly most convenient to locate the smoke detector at an opposite end of the device to its lens and light bulb (or other light source). However, the butt of a torch can be exposed to rough treatment, either accidentally or by being used as a base for the torch. The smoke detector thus risks being damaged. Also, particularly if the traveler is in a rural setting, the mesh housing could easily become blocked with mud or the like.

Indeed, a major drawback of the device shown in U.S. Pat. No. 4,862,148 may well be that it is not waterproof. It might be dropped in a river, for example, or caught in the rain, leading to malfunction of electrical components.

One other drawback of the device shown in U.S. Pat. No. 4,862,148 is the use of a simple on/off switch to control operation of the smoke detector. As a result, it may not be immediately obvious whether the detector has been switched on, and a user could inadvertently go to sleep, falsely relying on an inactive alarm.

It is hence an object of the present invention to provide a conveniently usable portable personal safety device, combining the full functions of torch and smoke alarm, while obviating the above disadvantages of existing devices.

According to the present invention there is provided a personal safety device comprising casing means, a means of illumination and smoke detector means enclosed by the casing means in a first, closed configuration of the device and accessible to a surrounding atmosphere in a second, open configuration of the device.

Preferably, the device is so configured as to be manually graspable.

Advantageously, the casing means comprises an elongate generally cylindrical housing means with the illuminating means mounted to a first end thereof and the smoke detector means mounted adjacent a second end remote from the first.

The smoke detector means may then extend axially outwardly from said second end of the housing means.

The housing means may be provided at said second end with end cap means to protect the smoke detector means.

The end cap means may close the housing means sealingly in the closed configuration of the device, and be displaced therefrom in the open configuration of the device.

Optionally, the smoke detector means may be movable between a stored disposition within the casing means and an operative disposition extending externally of the casing means.

The end cap means may then be mounted to the smoke detector means.

The device is preferably substantially waterproof when in its closed configuration.

Preferably, the smoke detector means comprises photodiode or phototransistor smoke detection means.

Advantageously, the smoke detector means is mounted within chamber means having walls apertured to allow passage of air therethrough.

The smoke detector means may comprise heat detector means, optionally comprising thermistor means, adapted to detect rapid rises in temperature.

The smoke detector means may be provided with audible and/or visible alarm means.

Said visible alarm means may comprise the illuminating means of the device.

The smoke detector means may be provided with control means disposed within the casing means, optionally within the housing means.

The control means may be adapted to activate the smoke detector means when the device is in its open configuration and to inactivate it when the device is in its closed configuration.

The control means may operate the alarm means in response to detection of smoke by the smoke detector means and/or detection of a rapid rise in temperature by the thermal detector means.

The device is preferably provided with means to bias it toward its open configuration, and selectably releasable catch means adapted to retain it in its closed configuration.

Preferably, the device is also provided with means for a user to operate the alarm means, so that the device may then also be used as a personal attack or panic alarm.

The audible alarm means may also be controllably operable, for example for signalling purposes.

The device is preferably provided with internal electrical power supply means, such as electrical storage cell means.

The internal power supply means may be rechargeable.

The device may then be provided with recharging socket means extending through the casing means.

Separate internal power supply means may be provided for each of the illuminating means and the smoke detector means.

Alternatively, a single internal power supply means may power the illuminating means and the smoke detector means.

The illuminating means preferably emits white light, optionally comprising one or more white light emitting diodes (LEDs).

The illuminating means may also emit coloured light, for example red light, optionally comprising an LED of a desired colour.

The illuminating means may be operable as signalling means.

The device may be provided with support means, such as stand means, suspension hook means, lanyard means or the like.

The device may be provided with means to link it to a user's person or property.

An embodiment of the present invention will now be more particularly described by way of example and with reference to the accompanying drawings, in which:

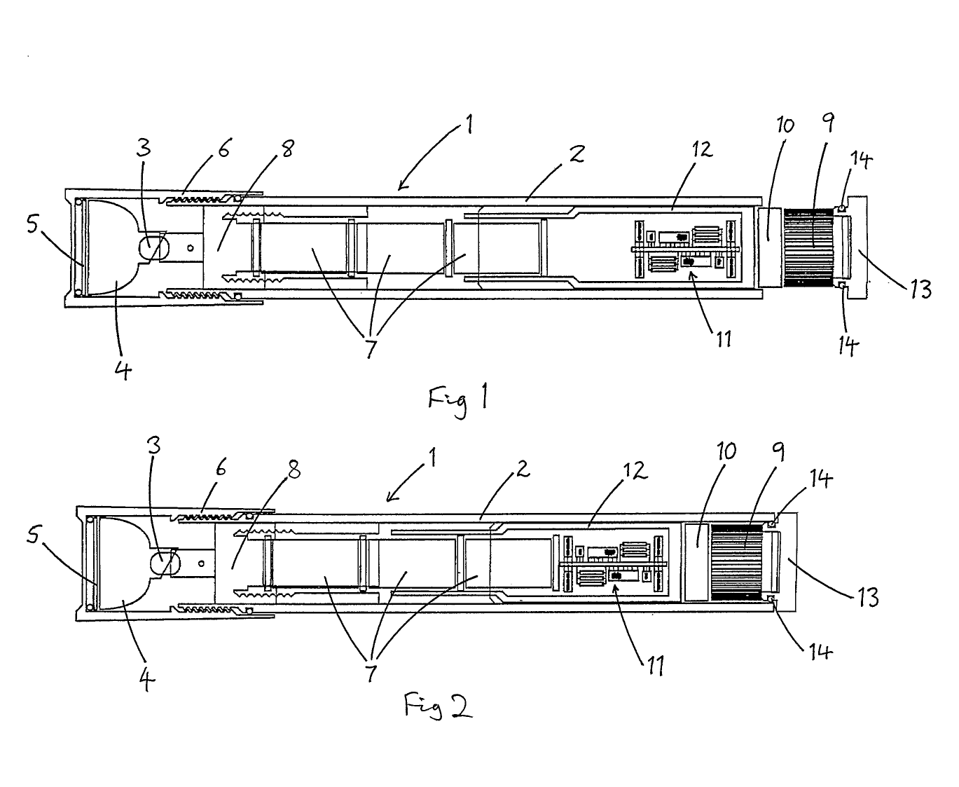

FIG. 1 is a partially-sectioned side elevation of a first safety device embodying the present invention, with smoke alarm functions in an operating configuration;

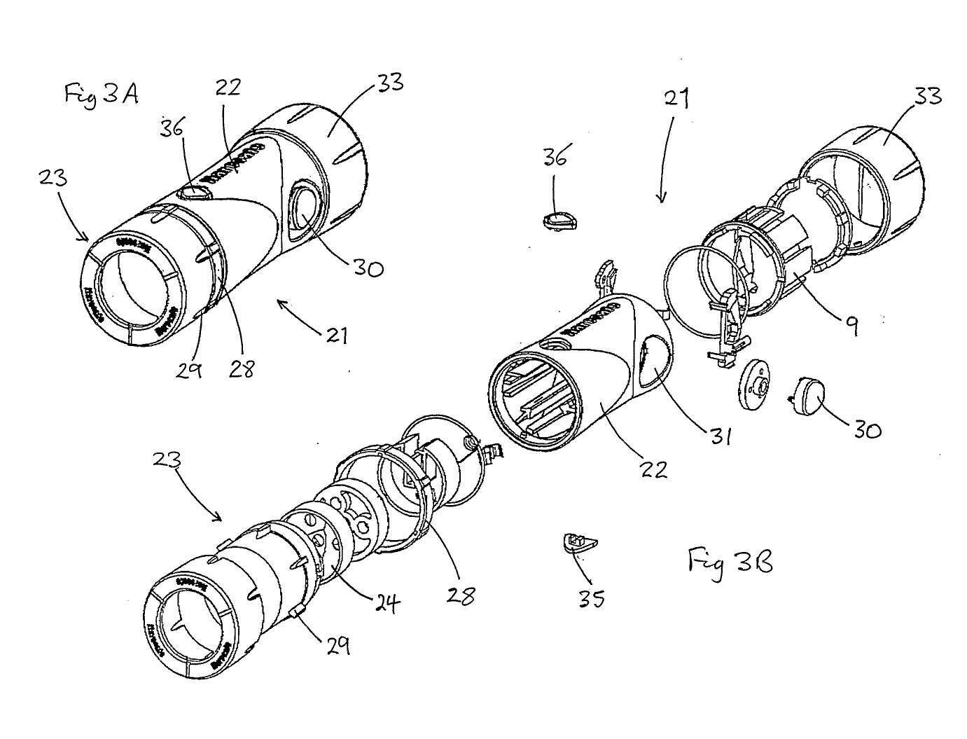

FIG. 2 is a partially-sectioned side elevation of the device shown in FIG. 1, with smoke alarm functions in an inactive configuration;

FIG. 3A is a perspective view of a second safety device embodying the present invention;

FIG. 3B is an exploded perspective view of the device shown in FIG. 3A;

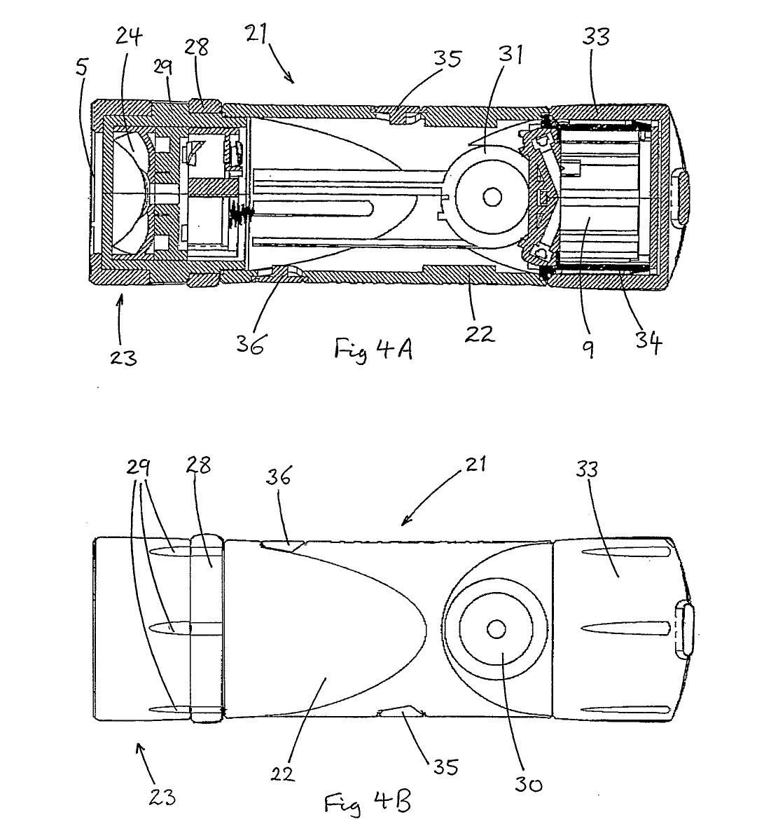

FIG. 4A is a cross-sectional side elevation of the device shown in FIG. 3A in an inactive configuration;

FIG. 4B is a side elevation of the device shown in FIG. 3A in an inactive configuration;

FIG. 4C is a cross-sectional side elevation of the device shown in FIG. 3A in an operating configuration;

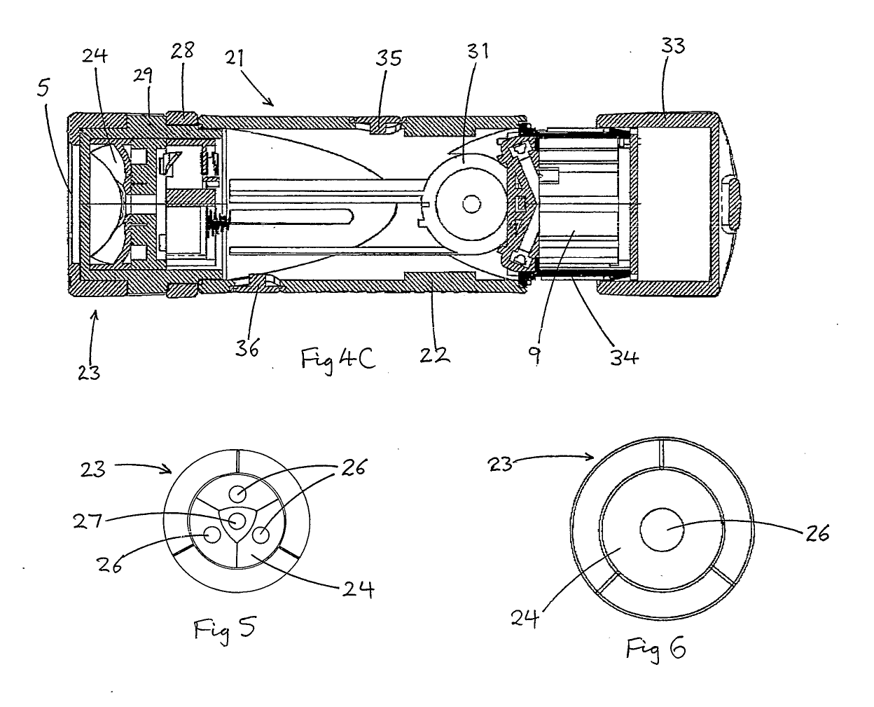

FIG. 5 is an end elevation of the device shown in FIG. 3A; and

FIG. 6 is an end elevation of an alternative torch section for the device shown in FIG. 3A.

Referring now to the Figures, and to FIG. 1 in particular, a first personal safety device 1 comprises a substantially cylindrical elongate outer casing 2, dimensioned to be conveniently graspable in one hand by a user. At a first end of the casing 2, there is provided a conventional torch arrangement comprising an electric light bulb 3 mounted within a reflector 4 behind a lens 5, so that it may project a beam of light generally axially of the cylindrical casing 2. A terminal portion 6 of the casing 2 is separable therefrom, for example to allow replacement of a defective bulb 3. The casing 2 may be of metal or a hard, strong plastics material, optionally coated with rubber or the like.

Three conventional dry cell electric batteries 7 are held within a central portion of the casing 2, and provide power to the bulb 3. A conventional on/off switch arrangement 8 is provided to operate the device 1 as a torch. The batteries 7 may be rechargeable batteries, in which case a sealable recharger socket is provided in the casing 2, linked to a conventional charging circuit (not shown).

At a second end of the casing 2, remote from the first, is provided a smoke alarm arrangement. A louvered cylindrical chamber 9 contains a photodiode or phototransistor smoke detector. Adjacent this is mounted an audible alarm sounder 10. Each of the smoke detector and the alarm sounder 10 is operatively connected to a smoke detector circuit 11, and all three are mounted to a frame 12, which is longitudinally slideably moveable within the casing 2. In an operating configuration, as shown in FIG. 1, the louvered chamber 9 and the sounder 10 are disposed externally of the casing 2, while the circuit 11 remains protected there within. In this embodiment, the smoke detector arrangement is powered by the batteries 7, although a dedicated battery may be provided if preferred.

A robust butt cap 13 is mounted to an end of the chamber 9 remote from the casing 2. An O-ring seal 14 is disposed in an annular recess encircling the butt cap 13.

In an inactive configuration, as shown in FIG. 2, the frame 12 has been displaced inwardly of the casing 2, such that the circuit 11, sounder 10 and chamber 9 are all disposed within the casing 2. The butt cap 13 closes the second end of the casing 2, the O-ring seal 14 contacting a rim of the casing 2 to provide a watertight seal.

In the operating configuration shown in FIG. 1, air may pass freely through the louvers of the chamber 9. Smoke particles would be registered by the smoke detector there within, which would pass a signal to the detector circuit 11. Once a predetermined critical concentration of smoke particles is reached, the circuit 11 causes the alarm sounder 10 to operate, alerting the user. In some embodiments, the bulb 3 is also automatically switched on.

When the smoke alarm is not required, the user pushes the butt cap 13 towards the casing 2. A latch (not shown) is provided to hold the frame 12 in place once it has reached the position shown in FIG. 2. The smoke detector circuit 11 is automatically switched off once the frame 12 has been pushed home in this way.

The latch is released by twisting the butt cap 13 by a quarter turn. The frame 12 is biased outwardly of the casing 2 by a spring (not shown), so the device 1 then returns to the operating configuration shown in FIG. 1, and the smoke detector circuit 11 is automatically switched on, once more.

Hence, if the chamber 9 is exposed, the smoke alarm arrangement is operating. A user can thus tell at a glance whether he is being protected by an operational alarm.

When the device 1 is in its inactive configuration, as shown in FIG. 2, it is fully usable as a conventional, robust, waterproof torch. Neither water nor other adventitious material can enter the chamber 9 or reach the smoke detector circuit 11. The chamber 9 and the smoke detector therein are securely shielded from physical damage by the casing 2 and the butt cap 13. It is however the work of a moment to set up the device 1 as a smoke alarm by returning it to its operating configuration.

The device 1 is the same diameter as and very little longer than a conventional torch, and the smoke detector arrangement adds little to its overall mass. The device 1 is thus equally as easy to transport and to handle.

The device 1 may optionally be provided with loops or hooks to allow it to be hung from a belt or pack in transit or from a convenient support when in use as a smoke alarm. It may also be stood on end with the terminal portion 6 of the casing 2 acting as a base; the terminal portion 6 extends beyond the lens 5 so as to protect it from damage in this disposition. A stand may also be provided for the device.

An additional switch arrangement may be provided to allow the alarm sounder 10 to be operated voluntarily, such that the device 1 may also be used as a personal attack alarm or the like, or to guide rescuers to the user.

FIGS. 3A to 6 show a second, preferred personal safety device 21. A main casing 22 of the second device 21 is profiled to be comfortably manually graspable. A preferred material for the casing is glass-reinforced polypropylene, although casings of metal or of other strong tough plastics materials, such as ABS, are also possible. Within the main casing 22, there are fittings and contacts to receive two first dry cell batteries, e.g. 1.5V AA size, primarily to provide power for a torch section 23 of the device 21, and a second lithium dry cell battery, for example a CR123A-size 3V lithium button cell battery, primarily to provide power for a smoke detector arrangement of the device 21 (see below).

The torch section 23 of the device 21 comprises, in a preferred embodiment, three white light-emitting diodes (LEDs) 26 and one red LED 27 arranged as shown in FIG. 5, with a reflector 24 shaped to project light from each LED 26, 27 as a substantially axial beam through a conventional lens 5.

The torch section 23 is operated by means of a rotatable circumferential ring 28, which has from four to six selectable positions relative to markers 29 incorporated in the torch section 23.

In a first position of the ring 28, the three white LEDs 26 are illuminated, producing a conventional white torch beam.

In a second position of the ring 28, the red LED 27 is illuminated instead. This provides sufficient illumination for night-time map-reading, for example, the red light leaving a user's night vision unaffected.

In a third position of the ring 28, the red LED 27 flashes on and off continually, acting as a distress beacon, for example to guide rescuers to someone trapped on a mountainside or other rough terrain at night.

In an off position, all the LEDs 26, 27 are extinguished.

In an alternative embodiment, as shown in FIG. 6, a single centrally-located white LED 26 is provided and the red LED 27 is omitted. The reflector 24 has a simple hyperboloidal profile in place of the complex profile required in the torch section 23 shown in FIG. 5. Other arrangements are also equally possible, comprising a plurality of white LEDs 26 but without the optional red LED 27.

The ring 28 and a butt cap 33 are a contrasting colour to the remainder of the torch section 23 and the main casing 22, and preferably comprise luminous or phosphorescent material to aid operation of the torch section 23 in the dark. The markers 29 are clear.

As for the first device 1, the smoke detector arrangement of the second device 21 is mounted at the opposite end of the main casing 22 to the torch section 23. However, there are slight differences in the arrangements for protecting and activating the smoke detector.

In a stored inactive configuration, the butt cap 33 encloses the louvered chamber 9 of the smoke detector, as shown in FIG. 4A. (The electronic circuitry 11 of the smoke detector is omitted, for clarity). As for the butt cap 13 of the first device 1, the butt cap 33 is retained by a bayonet-type catch, released by gripping and turning the butt cap 33. In this case, however, only the butt cap 33 moves, being biased to travel along a static frame 34 outwardly of the device 21, thus uncovering the chamber 9, as shown in FIG. 4C.

The butt cap 33 is a contrasting colour to the main casing 22, and as for the ring 28 preferably comprises luminous and/or phosphorescent material, allowing easy operation in the dark; the entire butt cap 33 then glows in the dark to distinguish it from the torch section 23.

In the stored configuration shown in FIG. 4A, the butt cap 33 forms a watertight seal with the main casing 22, completely protecting the chamber 9 and the smoke detector there within, which is inactivated. When the butt cap 33 is released as in FIG. 4C, and air can circulate through the chamber 9, the smoke detector is automatically switched on.

The second device 21 is provided with a photodiode or phototransistor smoke detector arrangement, similar to that of the first device 1, which registers smoke particles entering the chamber 9, and sets off an alarm when they exceed a predetermined concentration. The second device 21 is also provided with a thermistor-based thermal detector, which registers rapid increases in air temperature within the chamber 9, such as may be produced by rapidly-flaring fires in advance of significant smoke concentrations. The preferred thermal detector sets off the alarm if it registers a rate of temperature increase in excess or a predetermined threshold value. This threshold value may usefully be in the range of 0.1 to 50° C. per minute. A typical threshold value would be around 8° C. per minute.

The alarm of the second device 21 comprises a piezo-electric sounder 30 mounted within a recess 31 on the main casing 22. The preferred sounder 30 emits a loud alarm tone, which for example may reach 110 dB at source. The torch section 23 is simultaneously switched on to allow the user to see what is going on, and to pick up the device 21 for use as a torch to light his or her escape. The sounder 30 may be switched off simply by returning the butt cap 33 to its stored configuration.

The device 21 is most effective when hung high and generally centrally in a room, tent or the like, where hot air and smoke are most likely to collect, and a lanyard or suspension loop or hook may be provided to allow it to be hung from a convenient point.

The first dry cells will power both the torch 23 and the sounder 30. If the first dry cells run low on power, which would be indicated by dimming of the LEDs, an override circuit will in an emergency draw power from the second lithium dry cell to operate the alarm sounder 30 and the torch 23. In normal operation, the lithium dry cell will run the smoke detector arrangement for at least one year. When the lithium dry cell is sufficiently charged to operate the smoke detector, a single beep is emitted whenever the smoke detector is activated. Should the lithium dry cell start to run low, a sequence of beeps is emitted instead, warning that replacement is necessary. This warning is repeated every time the smoke detector is activated until a fresh lithium cell is inserted, or until the cell expires.

Two control buttons 35, 36 are provided on opposite sides of the main casing 22 These are of a contrasting colour to the main casing 22, and, as for the ring 28 and the butt cap 33, are preferably luminous or phosphorescent to aid operation in the dark. A first control button 35 operates the sounder 30, for example as an audible beacon in situations, such as thick jungle or woodland, where a visual beacon would be in effective. The sounder 30 stays on for as long as the first control button 35 is kept depressed, thus allowing signalling in Morse code or the like.

The second device 21 also incorporates an attack alarm feature. When the first control button 35 and the second control button 36 are depressed simultaneously, the sounder 30 emits a continuous loud alarm tone and the torch 23 is turned on. Once this alarm function has been activated, it can only be turned off by opening the device 21 and removing the dry cells. Merely releasing the control buttons 35, 36 has no effect, so the user may release the device 21, better to defend her or himself. Removing the first dry cells resets the alarm function, so that once they have been replaced the device 21 will operate as normal.

The second device 21 is sufficiently light and compact to be carried in a pack, a case, or even a pocket or a handbag. When the butt cap is in place over the smoke detector chamber, the device is waterproof against rain or even immersion. It is quick and easy to set up in a tent or a room with its smoke and fire detector functions activated, and should an alarm be raised, it is immediately available as a torch to aid escape.

In further embodiments of the invention, other forms of alarm device could also be included, such as a motion sensor, linked to the alarm sounder 10, 30. The device 1, 21 could then be used as an anti-theft alarm, for example when stored in or attached to a pack or other luggage.

The invention has been described as being of particular use to travelers, which it is. However, it may also prove effective in general domestic environments.

1. A personal safety device comprising casing means, a means of illumination and smoke detector means enclosed by the casing means in a first, closed configuration of the device and accessible to a surrounding atmosphere in a second, open configuration thereof

2. A personal safety device as claimed in claim 1, so configured as to be manually graspable.

3. A personal safety device as claimed in claim 1, wherein the casing means comprises an elongate generally cylindrical housing means with the illuminating means mounted to a first end thereof and the smoke detector means mounted adjacent a second end remote from the first.

4. A personal safety device as claimed in claim 3, wherein the smoke detector means extends axially outwardly from said second end of the housing means.

5. A personal safety device as claimed in claim 1, wherein the smoke detector means is movable between a stored disposition within the casing means and an operative disposition extending externally of the casing means.

6. A personal safety device as claimed in claim 1, which is substantially waterproof in its closed configuration.

7. A personal safety device as claimed in claim 1, provided with means to bias the device towards its open configuration, and selectably releasable catch means adapted to retain it in its closed configuration.

8. A personal safety device as claimed in claim 1, wherein the smoke detector means is provided with control means adapted to activate it when the device is in its open configuration and to inactivate it when the device is in its closed configuration.

9. A personal safety device as claimed in claim 1, wherein the smoke detector means comprises photodiode or phototransistor smoke detection means.

10. A personal safety device as claimed in claim 1, wherein the smoke detector means comprises heat detector means, adapted to detect rapid rises in temperature.

11. A personal safety device as claimed in claim 1, wherein the smoke detector means is provided with audible and/or visible alarm means.

12. A personal safety device as claimed in claim 11, wherein said visible alarm means comprises the illuminating means of the device.

13. A personal safety device as claimed in claim 11, provided with means for a user to operate the alarm means, so that the device may then also be used as a personal attack or panic alarm.

14. A personal safety device as claimed in claim 11, wherein the alarm means is controllably operable, for example for signaling purposes.

15. A personal safety device as claimed in claim 1, wherein the illuminating means emits white light, optionally comprising one or more white light emitting diodes (LEDs).

16. A personal safety device as claimed in claim 1, wherein the illuminating means emits colored light, for example red light, optionally comprising an LED of a desired colour.
